(19) United States
(12) Patent Application Publication
(10) Pub. No.: US 2011/0137782 A1
(43) Pub. Date: Jun. 9, 2011

(54) SYSTEM AND METHOD OF RECORDING, SHARING, AND STORING DATA AND MATERIALS FOR SELECTIVE RETRIEVAL

(76) Inventor: Zhihua Fang, Canton, MI (US)

(21) Appl. No.: 12/632,780

(22) Filed: Dec. 7, 2009

(51) Int. Cl. G06F 17/30; G06Q 40/00; G06Q 50/00

(52) U.S. Cl. 705/35; 707/805; 707/781; 707/769; 707/E17.005; 707/E17.044; 707/803; 707/E17.014

(57) ABSTRACT

A method, a process, and a location for a customer to store life-time memories, feelings, emotions, and consciousness, or any other mental activity in a permanent database, based on a financing plan, aided by a collection of personal physical artifacts and personal biological data and materials in permanent physical storage, to share personal and communal information and physical collection with others, to build virtual and permanent personal and collective identities, and to prepare for the possible and probable human immortality where evocation of personal and communal consciousness and information is required when technology avails itself to make our consciousness alive again, either in biological form, in electronic form, in electro-biological form, or in any other possible form, so that our individual consciousnesses will live on both as separate entities and possibly form a unity with one another, in a state of community or singularity, thus achieving immortality.

### CROSS-REFERENCE TO RELATED APPLICATIONS

This application claims the benefit of provisional patent application Ser. No. U.S. 61/200,743, filed on Dec. 3, 2008, which is hereby incorporated by reference, in its entirety.

### BACKGROUND OF THE INVENTION

### Field of Invention

This invention relates to a system and method of recording, sharing, and storing data and materials for selective retrieval.

### BACKGROUND OF THE INVENTION

While much debate goes on about the reality and future of human immortality, the latest thinking not only points to its possibility, but almost inevitable probability. To understand the probability of human immortality in one form or another, let's start with the discovery and assertion of Francis Crick, the co-discoverer of DNA, who says this about human consciousness (or the “soul”) in his seminal book The Astonishing Hypothesis: The Scientific Search for the Soul:

The astonishing Hypothesis is that “You,” your joys and your sorrows, your memories and your ambitions, your sense of personal identity and free will, are in fact no more than the behavior of a vast assembly of nerve cells and their associated molecules.

Nothing more hopeful has ever come out of human existence than expressed in the quote above. What Francis Crick has pointed out is that, as humans, we will no longer need to rely on the existing 3 biological form we have taken to prolong our existence. Why? If our consciousness can be understood to be “the behavior of a vast assembly of nerve cells and their associated molecules,” then who is to say that this assembly of nerve cells and their associated molecules cannot be recreated or duplicated and then maintained to sustain our consciousness forever, thus enabling us to live forever? Who is to say that this behavior of a vast assembly of nerve cells and molecules cannot be achieved and maintained in some electronic or electro-biological form?

Ray Kurzweil, of Kurzweil Industries, has authored numerous books on the future development of the human race and on how technology will soon enable us to live forever. To his credit, he is widely known to have predicted the fall of Communism in Eastern Europe in his hooks; and there are many other predictions by him that have come truth. Bill Gates declares Ray Kurzweil to be the best person I know at predicting the future of artificial intelligence.”

Here is the prediction of Ray Kurzweil about how technology will usher in human immortality in his best-selling book The Singularity Is Near:

. . . within several decades information-based technologies will encompass all human knowledge and proficiency, ultimately including the pattern-recognition power, problem-solving skills, and emotional and moral intelligence of the human brain itself.

. . . We will gain power over our fates. Our immortality will be in our own hands. We will be able to live as long as we want . . . . We will fully understand human thinking and will vastly extend and expand its reach. By the end of this century, the non-biological portion of our intelligence will be trillions of trillions of times more powerful than unaided human intelligence.

[When we reach the state of Singularity,] it will represent: the culmination of the merger of our biological thinking and existence with our technology, resulting in a world that is still human but that transcends our biological mots. There will be no distinction, post-Singularity, between human and machine or between physical and virtual reality. If you wonder what will remain unequivocally human in such a world, it's simply this quality: ours is the species that inherently seeks to extend its physical and mental reach beyond current limitations.

Essentially, these two experts, along with numerous others, have pointed to one unavoidable course of human development: our biological existence will soon be augmented or replaced by a non-biological or electro-biological existence, in one way or another, which may well usher in the age of immortality.

### SUMMARY OF THE INVENTION

Essentially, Immordata is a method, a process, and a venue for our customers to store their electronic and biological data, as well as personal physical artifacts and biological data, for the purpose of creating an immortal consciousness, to share personal and communal information with others, to build virtual and permanent personal and collective identities, and to prepare for the possible and probable human immortality where evocation of personal and communal consciousness and information is required.

### BRIEF DESCRIPTION OF THE DRAWINGS

FIG. 1 is a schematic diagram illustrating an exemplary system for data gathering, storing, and sharing;

FIG. 2 is an exemplary website for the system interface between customers and data;

FIG. 3 is an exemplary website interface where customers can to in to access the customer's account;

FIG. 4 is an exemplary website interface where customers may choose a data category to enter or retrieve the customers' data;

FIG. 5 is an exemplary website interface where customers may designate the category in which the customers may enter data;

FIG. 6 is an exemplary website interface where customer may record, enter, and retrieve audio data;

FIG. 7 is an exemplary website interface where customers may record, upload, and retrieve visual data;

FIG. 8 is an exemplary website interface where customers may record, upload, and retrieve other electronic data;

FIG. 9 is an exemplary website interface where customers may store and retrieve personal physical artifacts;

FIG. 10 is an exemplary website interface where customers may store and retrieve personal biological data and materials;

FIG. 11 is an exemplary website interface where customers may create various communities of any kind and size; and

FIG. 12 is a flowchart: detailing the method and system in which customers create accounts and communities, store data, share data, and retrieve data.

### DETAILED DESCRIPTION

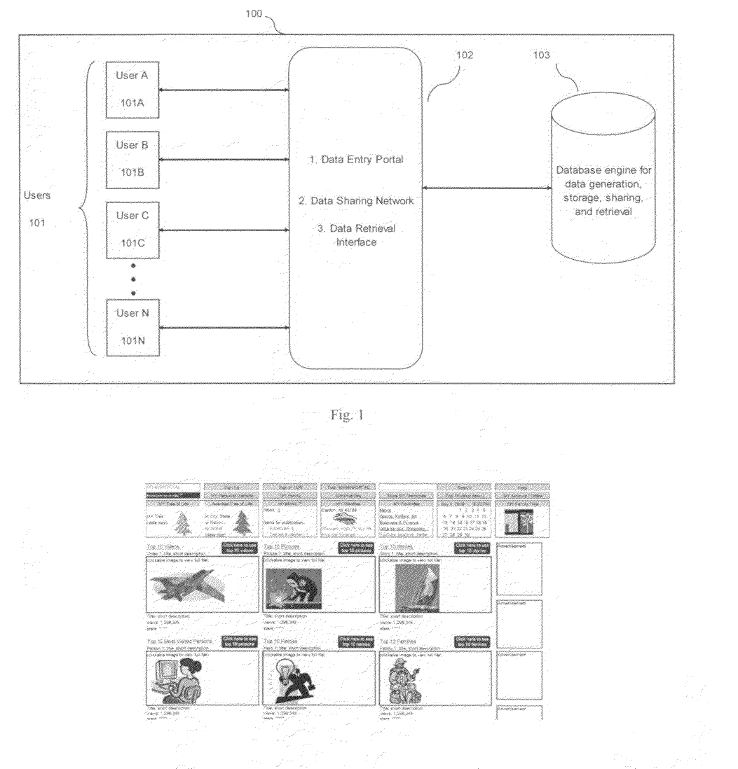

Here is the detailed description of how the Immordata will work, referring to the drawings, wherein like reference numbers refer to like components, a selective storage and retrieval system is shown at 100 in FIG. 1. The selective storage and retrieval system includes a network 102 operatively connected to a database 103. One or more users 101, such as a User A 101A, a User B 101B, a User C 101C, and a User N 101N, are in communication via a network with a network engine 102. The network engine 102 may include a website, one or more servers operating the networking website, or any other device or application capable of providing networking services via the network 102. The users 101 can access the services provided by the network engine via the network 102. Optionally, one or more of the users 101 may be able to access the network engine 103 directly.

The users 101 can access the network engine 102 via a computing device, such as a laptop or desktop computer, a cellular telephone, a personal digital assistant (PDA), a set top box, and so forth. The users 101 can view data about social network members via the network engine 102, enter data about themselves and possibly others, join network groups, and so forth. The users 101 are typically members of a networking website associated with the network engine 102, for example, and thus include the network members.

### The Immordata Process, Method, and Other Elements:

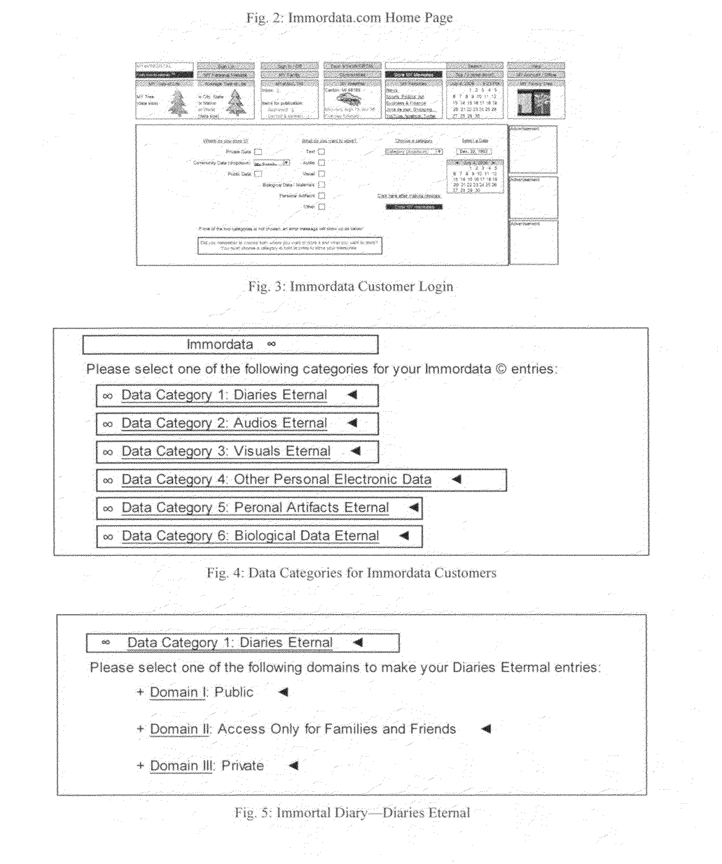

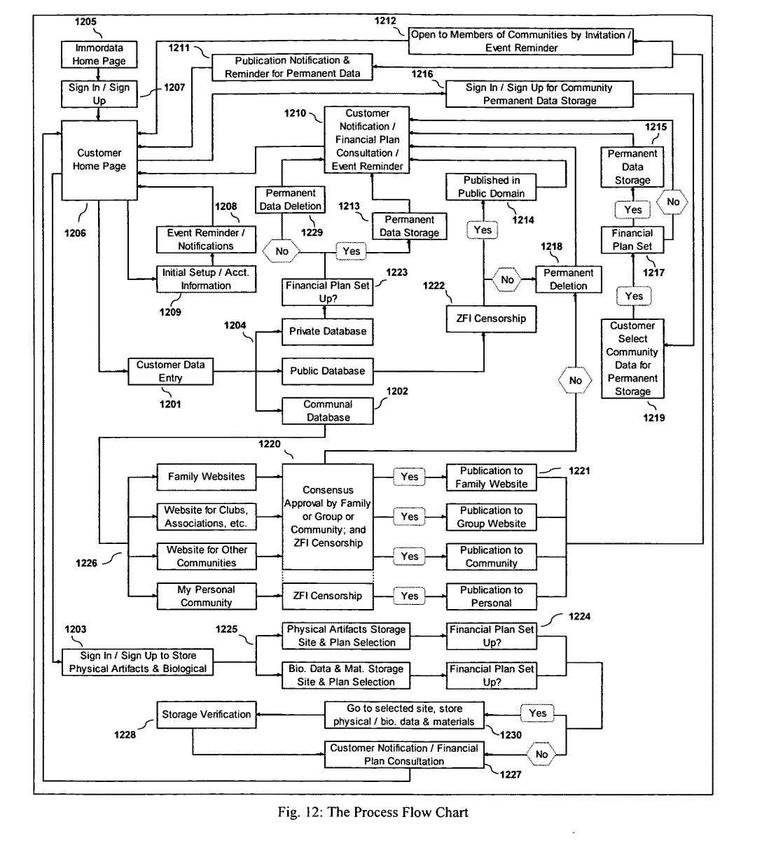

1. Immordata customers enter the website by using the process detailed below:
1.1. When customers enter the Immordata website, Immordata's home page will greet them, as shown in FIG. 2.
1.2. Immordata customers will sign in by using the sign-in website set up for the customers, where customers will need to use a User Name or an Email Address and also a User Password in order to enter the website, as shown in FIG. 3.
2. The Immordata Website: Immordata will establish the website for data storage, data sharing, and the building of Immordata individuals, families, communities, cities, states, ethnicities, countries, the United Nations, and possibly the entire immordata humanity:
2.2. Web portals will be established as portals for customers to enter 1201, store, update, and share their written, audio, video, and all other electronic and personal data via the web interface, as shown in FIG. 12 at 1205. The data will be segmented into three distinct categories as shown in FIG. 12 at 1204: 1) one for public sharing, so others may have access to various published data, 2) one for sharing only within circles of family, friends, or any other community, and 3) one for private documentation that will only be viewed by each individual who enters the data and can be brought up as permitted by the executors of Immordata in the future for eventual establishment of individual immortality, as authorized by the individual in legal agreements.
2.3. Data submitted for publication will be subjected to data administrators' censorship as in FIG. 12 at 1220 and 1222. Once the submitted data passes censorship, the data will be published either to the general Internet public 1214 or to communities 1221 lithe submitted data does not pass censorship, the data will be permanently deleted 1218 and 1229 and the customer will be notified 1210.
2.4. Customers will be reminded to store their data permanently 1211 and customers can then submit data for permanent storage as in FIG. 12 at 1213 and 1215, but customers must sign up for financing plan, as shown at 1216, 1217 and 1223. If the financing plan is set up, then data is stored permanently 1213 and 1215
2.5. The websites will also enable our customers to build their communities 1226 as specified below, be they families, communities, races, ethnicities, countries, or all of humanity. As shown in FIG. 12, customers will be able to share their personal information to build communities of their own as they see fit at 1202. The data for these communities can be permanently stored or not, depending on the agreements between Immordata and these communities.
2.6. The websites will also direct our customers to store their Personal Physical Artifacts in storage centers across the globe in secure, locked-down, fire-proof, and quake-resistant facilities and the websites will also direct customers to store biological materials in biological storage in Immordata biological storage centers across the globe in secure lockdown, fire-proof, and quake-resistant facilities as shown in FIG. 12 at 1203 and 1225. Customers will be required to set up a financing plan 1224. If the customer does not have a financing plan set up, the customer will be rejected and notified 1227; if the customer has a financing plan, then the customer will be able to store physical artifacts and biological materials 1230 and the customer will be notified of the storage 1228.
3. Immordata process and method: This is the process and method for customers to store their daily activities, memories, feelings, emotions, and reflections, etc. Furthermore, Immordata customers will be able to save their personal physical artifacts and biological data as instructed by Immordata. The process and methods are listed below and shown in FIG. 4:

Data Category 1: Diaries Eternal

Data Category 2: Audios Eternal

Data Category 3: Visuals Eternal

Data Category 4: Other Personal Electronic Data

Data Category 5: Personal Artifacts Eternal

Data Category 6: Biological Data Eternal

### 3.1. Immortal Individuals:

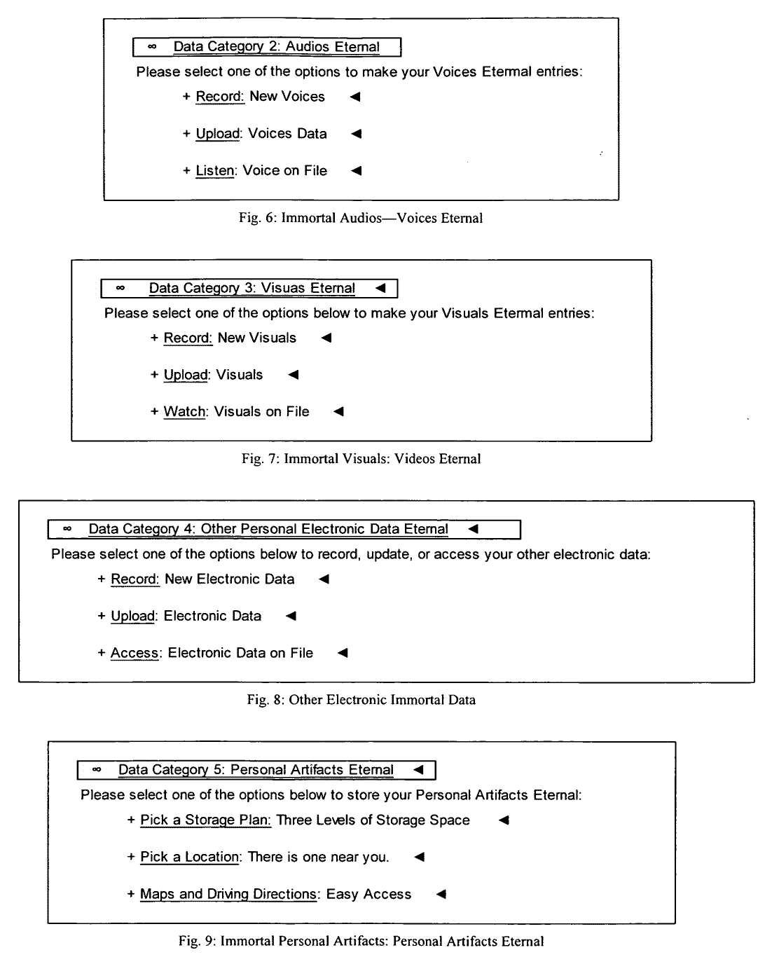

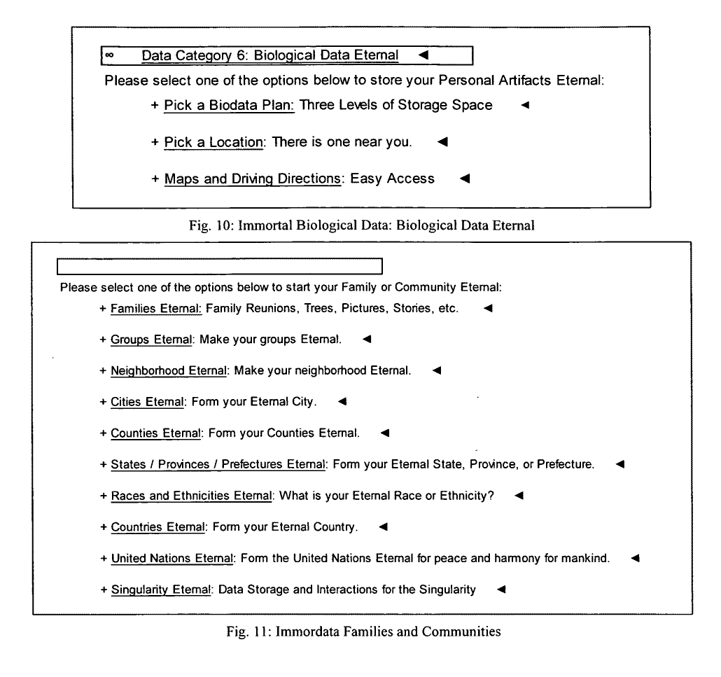

3.1.1. Immortal Written Entries: this is probably the best, the most direct, and the most intimate way to record one's consciousness for eternity. Customers' written entries of their memories and feelings, completed daily or otherwise, shall be stored permanently, to be used by our customers to build their own eternal consciousness and to build immortal communities of various kinds and sizes. As shown below, the contents of the immortal written entries will be categorized into three: 1) Public, 2) Access Only for Families and Friends and Communities, and 3) Private. This function and the categorization will define all other data below to be stored with Immordata as shown in FIG. 5. The descriptions of the three categories will be further defined later in this patent application.
3.1.2. Immortal Audios: This shall be the voice recordings of our customers or other sounds and voices; the data is less direct, but it has dimensions unavailable in written words; it also records our biological vocal dimension and enriches the contents of the recorded consciousness. The contents of this kind of data will also have three categories: Public, or Access Only for Families and Friends and Communities, or Private. The audio recordings shall be stored permanently, to be used by our customers to build their own eternal consciousness and to build immortal communities of various kinds and sizes. Immordata customer will enter, modify, or retrieve their data by using the Immordata website as shown in FIG. 6.
3.1.3. Immortal Visuals: These are pictures or videos of customers; this data adds an even richer form of recording our consciousness, especially when we are recorded to discuss our memories, feelings, emotions, and reflections, or when they record other activities and observations. It also adds physical dimensions unavailable in audio and written recordings. The contents of this kind of data will also have three categories: Public, or Access Only for Families and Friends and Communities, or Private. These data elements are valuable in case our immortality may require sonic physical dimensions to establish our immortality. The visual recordings shall be stored permanently to be used by our customers to build their own eternal consciousness and to build immortal communities of various kinds and sizes. Immordata customer will enter, modify, or retrieve their data by using the Immordata website as shown in FIG. 7.
3.1.4. Other Electronic immortal Data: Customer may record any other electronic data they deem necessary to record their consciousness, such as medical records, publications of relevant subjects or events, or whatever electronic data. This data will enrich recordings of customers' consciousness. The contents of this kind of data will also have three categories: Public, or Access Only for Families and Friends and Communities, or Private. These recordings shall be stored permanently to be used by customers to build their own eternal consciousness and to build immortal communities of various kinds and sizes. Immordata customer will enter, modify, or retrieve their data by using the Immordata website as shown in FIG. 8.
3.1.5. Immortal Personal Artifacts: This will be a collection of personal physical artifacts, in limited spaces, to aid in the revival of personal consciousness of our customers. These personal physical artifacts, be they scrapbooks, old photos, letters, small collections, samples of any materials things with personal connections, will be stored permanently for customers, to be used by our customers to build their own eternal consciousness and to build immortal communities of various kinds and sizes. Immordata customer will enter, modify, or retrieve their data by using the Immordata website as shown in FIG. 9.
3.1.6. Biological Data Eternal: This will be a collection of personal biological data, to aid in the revival of personal consciousness of our customers. This personal biological data, whatever form it may take (DNA, tissue, MRI, etc.), will be stored permanently for customers, to be used by our customers to build their own eternal consciousness and to build immortal communities of various kinds and sizes. Immordata customer will be able to update their biological information continuously. The process for biological data storage is shown in FIG. 10.
3.2. Immortal Families: The data for the Immordata Families can be permanently stored or temporarily stored, based on the agreements between Immordata and the families:
3.2.1. Family Trees: Families can use the Immordata website and process to build their family trees, to share their activities, news, thoughts, photos, videos, physical artifacts, or any other such information as specified in the content categories later in this application. Access to the data can be categorized to allow different access permissions, such as public or family only.
3.2.2. Family Rooms: Families can use the Immordata website and process to share information on their family trees, to conduct live gathering on the web and record their activities, thoughts, feelings, voices, and all other information as specified in the content: categories later in this application. Families may also use the Family Rooms to record their birthdays, anniversaries, special events, etc., and Immordata will provide the service to send reminders to specified customers for those dates and events. Families may also use the Family Rooms to plan travels, events, and gatherings; and then they may use the Family Rooms to upload event photos, videos, audio recordings, and descriptions, etc., to be share among family members. Access to the data can be categorized to allow different access permissions, such as public or family only.
3.9.3. Family Eternal Child-Raising: As children, up to a certain age, cannot record their activities, families can use the Immordata website and process to record the activities of their children, to be shared with the children when they are old enough to record their own activities, memories, feelings, thoughts, knowledge, etc.
3.2.4 Family Reunions: Families can use the Immordata website and process for electronic family reunions, via web casts, live videos, or conference calls, on the web and then record their activities, thoughts, feelings, voices, and all other information as specified in the content categories later in this application. Access to the data can be categorized to allow different access permissions, such as public or family only.
3.2.5. Family Medical and Genetic Records: Families or individuals can use the Immordata website and process to record medical and genetic information, which will be accessible only to the individuals themselves or to others who are given the access by the collective family or their doctors who are granted the access by the collective family decisions.
3.2.6. Family Living Will: Families can use the Immordata website and process to record their will. This data will be accessible only to the family members who are given the access by the collective family or their lawyers who are granted the access by the collective family decisions or the government as mandated by the applicable law under the appropriate and applicable jurisdiction.
3.2.7. Families Immortal: Families can use the Immordata website and process to record and store immordata for the entire family and record their activities, thoughts, feelings, voices, and all other information as specified in the content categories later in this application. Access to the data can be categorized to allow different access permissions, such as public or family only.

### 3.3. Immortal Communities:

3.3.1. Immortal Hoods: Individuals can use the Immordata website and process to build their immortal communities, be they neighborhoods, groups and communities of whatever specialty, such as artists, engineers, writers, inventors, etc., to share their products, activities, news, thoughts, photos, videos, physical artifacts, or any other such information as specified in the content categories later in this application and record their activities, thoughts, feelings, voices, and all other information as specified in the content categories later in this application. They may also use the immordata website to plan events and make announcements. Access to the data can be categorized to allow different access permissions, such as public or community only.
3.3.2. Immortal Cities: Individuals or cities can use the Immordata website and process to build their immortal cities, to share their products, activities, news, thoughts, photos, videos, physical artifacts, or any other such information as specified in the content categories later in this application and record their activities, thoughts, feelings, voices, and all other information as specified in the content categories later in this application. They may also use the Immordata website to plan events and make announcements. Access to the data can be categorized to allow different access permissions, such as public or community only.
3.3.3. Immortal States: Individuals or states can use the Immordata website and process to build their immortal states or provinces or prefectures or whatever administrative regions, to share their products, activities, news, thoughts, photos, videos, physical artifacts, or any other such information as specified in the content categories later in this application and record their activities, thoughts, feelings, voices, and all other information as specified in the content categories later in this application. They may also use the Immordata website to plan events, conduct business, and make announcements. Access to the data can be categorized to allow different access permissions, such as public or specific community only.

### 3. Immortal Universities:

3.4.1. As one of the purposes of Immordata is to establish a world in which learning will be for eternity for all interactive immordata individuals, it is fit and proper that Immortal Universities are to be established to benefit Immordata individuals. The purpose here may not be a diploma, but, instead, the Immordata individuals will matriculate into better beings all around, transcending the biological limitations.
3.4.2. Existing colleges and universities will set up their Immordata Colleges, Institutes, Universities, or any learning institutions of all kinds at the Immordata website to offer their education, for a fee, and to become a part of the Immordata world.
3.4.3. They may also use the Immordata website to plan events and make announcements. Access to the data can be categorized to allow different access permissions, such as public or community only.
3.4.4. Immordata will have the option to create its own Immordata University or any other higher education institution and offer its higher education services to Immordata customers and individuals.

### 3.5. Immortal Races and Ethnicities:

3.5.1. Immortal races: Individuals or collective races can use the Immordata website a id process to build their racial communities, to share their cultural data, activities, news, thoughts, photos, videos, physical artifacts, or any other such information as specified in the content categories later in this application and record their activities, thoughts, feelings, voices, and all other information as specified in the content categories later in this application. They may also use the immordata website to plan events, conduct their business, and make announcements. Access to the data can be categorized to allow different access permissions, such as, public or community only.
3.5.2, Immortal ethnicities individuals or collective ethnicities can use immordata website and process to build their ethnic communities, to share their cultural data, activities, news, thoughts, photos, videos, physical artifacts, or any other such information as specified in the content categories later in this application and record their activities, thoughts, feelings, voices, and all other information as specified in the content categories later in this application. They may also use the immordata website to plan events, conduct their business, and make announcements. Access to the data can be categorized to allow different access permissions, such as public or community only.

### 3.6. Immortal Countries:

3.6.1. Immortal countries: Sovereign countries or states can use the Immordata website and process to build their country or state communities, to share their data, activities, news, thoughts, photos, videos, physical artifacts, or any other such information as specified in the content categories later in this application and record their activities, thoughts, feelings, voices, visuals, and all other information as specified in the content categories later in this application. They may also use the Immordata website to plan events, conduct their business, and make announcements. Access to the data can be categorized to allow different access permissions, such as public or community only.
3.6.2. Immortal United Nations: The United Nations can use the Immordata website and process to share their data, activities, news, thoughts, photos, videos, physical artifacts, or any other such information as specified in the content categories later in this application and record their activities, thoughts, feelings, voices, and all other information as specified in the content categories later in this application. They may also use the Immordata website to plan events and make announcements. Access to the data can be categorized to allow different access permissions, such as public or community only.

### 3.7. Immortal Humanity:

3.7.1. This is far-sighted, but if the Singularity occurs, as predicted by Ray Kurzweil, the entire Singularity may use the Immordata website and process to share their data, activities, news, thoughts, knowledge, photos, videos, physical artifacts, or any other such information as specified in the content categories later in this application and record their activities, thoughts, feelings, visuals, voices, and all other information as specified in the content categories later in this application.
3.7.2. Were that to happen, the Singularity may use the Immordata website and its process for whatever purposes, but within the confines of the law at the time when the Singularity occurs.

In FIG. 11, there is a preliminary webpage that enables Immordata customers to form their Immortal Families, Communities, Neighborhoods, Groups, Cities, Countries, Ethnicities. States/Provinces/Prefectures, United Nations, or whatever community, or the Singularity, as shown in FIG. 11.

In FIG. 12, a high-level flow chart delineates the process that governs the operations of Immordata process.
4. The Data Base Storage: Data storages will be established to permanently and securely store our customers' data resulting from our customers' writings, recordings, and collections.
4.1. Electronic data will be stored at the secure sites. Security will be of the uttermost importance, so the data storage will be established in the most secure locations.
4.1.1. Legal agreements will be established with customers on how data is to be shared or protected, and on how the eventual data will be used to establish individual immortality by using the data of their consciousness. The latest technology is available to store electronic data for thousands of years, and future technology will avail itself to preserve the data permanently.
4.1.2. Data Integrity: Immordata will establish a process in which the data will be stored permanently; Immordata will make sure Immordata data will forever be securely stored and will be safe to retrieve by ensuring all technological updates for the data storage.
4.2. Physical collections of Immordata customers will be stored in secured, fire-proof, water-proof, quake-resistant, and damage-proof storage facilities, to aid in the eventual evocation or retrieval of the consciousness data, in order to establish individual immortality by using their data of their consciousness. Security will be of the uttermost importance, so the data storage will be established in the most secure location.
4.3. Biological data: In case the future requires biological data, permanent DNA data and other biological data will be stored to enable customers to store their biological data, in case the eventual building of individual immortality needs the biological data. At the suitable time, Immordata may choose to form its own biological data storage company, so our customers will trust that their biological data is secure with Immordata, like the other data they have storied with Immordata,

### 4.4. Financing Plan:

4.4.1. A financing plan will be established as an option for Immordata customers to enable the permanent data storage, until such a time as it is viable to transfer the Immordata from storage to a non-biological or altered biological form to let it: live permanently. The financial cost for permanent storage of all this data will be born by the principal amount in the form of an endowment and the resulting interest, as established by the financing plan.
4.4.2. Some of the Immordata costs will be borne by the income from advertising revenues as part of the Immordata is made public for viewing, discussion, and exchange.

### 5. Evocation of Immordata to Build Immortal Individuals, Families, or Communities of Varying Scales

5.1. immordata will select an executive committee of the best scientists, community leaders, and prominent citizens in the world and form the Immordata Congress, whose responsibility is to assess the maturity of the technology to build and sustain immortal individuals in the future. The structure and decision-making process shall be determined by Immordata.
5.2. The decision of the Immordata Congress will be the decision Immordata will follow to evoke the private and public data to build immortal individuals.
5.3. The process to execute this decision will be outline by the Immordata Board of Directors and its executive officers, to be detailed in its company charter.
5.4. Immordata shall abide by all laws in the community in which it operates for all its operations and activities, without exception.

### Further Definition of Immordata Contents:

This section is to detail some of the contents of the immordata, but not exclusively, so the patent's utility and its ease of application can be easily understood.

1. Life Story: Below is a potential but not exhaustive list of events, things, people, places, and any other information, that: the Immordata customers may record, update, and store:
1.1. Memories of events at different stages in life:
1.1.1. early childhood
1.1.2. mid childhood
1.1.3. late childhood
1.1.4. teenage years
1.1.5. beginning of adulthood
1.1.6, college years
1.1.7. early professional years
1.1.8. middle professional years
1.1.9. middle age
1.1.10. conclusion of work life
1.1.11. retirement
1.1.12. any other events, real or imaginary or in dreams
1.2. People you know:
1.2.1. family members
1.2.2. friends
1.2.3. colleagues
1.2.4. neighbors
1.2.5. acquaintances
1.2.5. others you have met and known
1.2.7. any other people, real or imaginary or in dreams
1.3. Accomplishments of your life:
1.3.1. tasks you have accomplished with pride
1.3.2, plans for accomplishing future tasks
1.3.3. awards, prizes, certificates, diplomas, etc.
1.3.4. any and all accomplishments
1.3.5. things you wish you could accomplish
1.4. Knowledge you have:
1.4.1. things you have learned in school
1.4.2. things you have learned for your jobs
1.4.3. things you have learned about life's daily activities
1.4.4. things you have learned about the world
1.4.5, trivia
1.4.6. any other knowledge
1.5. Places where you have lived:
1.5.1. birth place
1.5.2. cities or villages or whatever place you have lived in
1.5.3, places where you have worked
1.6. Places you have visited:
1.6.1. places you have visited
1.6.2. recollections of those places that you have visited
1.7. Places you have dreamt about:
1.7.1. dreamscape: places you have dreamt up in sleep
1.7.2, places you have conjured up in daydreaming
1.7.3. imaginary communities or places you have conjured up creatively
1.7.4. any other place that has come to your mind or conscience
1.8. Places you wish to visit:
1.8.1. places you have read about and wish to visit
1.8.2. places you have seen visually but wish to visit in person
1.8.3. any other place you wish to visit
2. Feelings, Emotions, Thoughts, or any other mental activity or state: Immordata customers can use the Immordata website and databases to build their consciousness; that is, everyone can continuously make entries under each feeling, emotion, and thought in the categories (though not exclusive) listed below. This will enrich the volume of the consciousness, making sure that your consciousness is entirely you, beautifully you, and glorious you, rich, plentiful, detailed, and fully dimensioned. Furthermore, all the rich experiences, emotions, wisdom, and knowledge, etc., will build a collective human consciousness that is more interactive than otherwise possible. The vision is that, as an aggregate whole, this collective human consciousness, as supported by the individual consciousness, will evolve into something far greater than anything that we have thus far witnessed in human civilization. And, if we have the far-reaching vision of billions of years from now, we will need this collective human consciousness and knowledge to jump out of this universe, as this universe is, based on scientific consensus, to collapse in one way or another. If that is to happen, the most probable way to escape this universe is the electronic collective consciousness that Immordata and its customers and users will be able to start building.
2.1. Below is a list of possible but not exhaustive feelings, memories, emotions, thoughts, etc., which an Immordata customer can record and store:
2.1.1. happiness
2.1.2. joy
2.1.3. sympathy
2.1.4. understanding of humor
2.1.5. feeling of humor
2.1.6. empathy
2.1.7. ponderings
2.1.8. outrage
2.1.9. emotional discoveries
2.1.10. hatred
2.1.11. arrogance
2.1.12. regrets
2.1.13. pride
2.1.14, shame
2.1.15. disappointment
2.1.16. bias
2.1.17. resentment
2.1.18. envy
2.1.19. jealousy
2.1.20. yearning
2.1.21. dreams
2.1.22. wishes
2.1.23. desires
2.1.24. urges
2.1.25, anxiety
2.1.26, concerns
2.1.27. worries
2.1.28. peeves
2.1.29, love
2.1.30. bitterness
2.1.31, pain
2.1.32. suffering
2.1.33. frustration
2.1.34. depression
2.1.35. trivial and useless thoughts
2.1.36. musings
2.1.37. arrogance
2.1.38, snobbery
2.1.39. boredom
2.1.40. sweetness
2.1.41. bliss
2.1.42. exaltation
2.1.43. tedium
2.1.44. orgasm
2.1.45. sexual sensations
2.1.46, comfort
2.1.47. tactile touch and sensations
2.1.48. feel of different materials
2.1.49. athletic movements and reflexes
2.1.50, moral judgment
2.1.51, social responsibilities
2.1.52. communal duties and obligations
2.1.53. what you deem as the norm of society
2.1.54. what: to you is not acceptable social behavior
2.1.55. what you wish to know
2.1.56, what you wish to improve
2.1.57. what you would change about the world
2.1.58. how to build consensus and the importance of it
2.1.59. political opinions
2.1.60. uneasiness
2.1.61. fainting feeling
2.1.62, queasiness
2.1.63. madness
2.1.64. drunken feeling
2.1.65, elation
2.1.66, sadness
2.1.67. bewilderment
2.1.68, panic
2.1.69. sensations of heat, cold, chill, dryness, humidness, etc.
2.1.70. curiosity
2.1.71. embarrassment
2.1.72. hole-in-the-ground moments
2.1.73. earliest memories
2.1.74. betrayal
2.1.75. stubbornness
2.1.76. vengeance
2.1.77. all tastes
2.1.78. cowardice
2.1.79. hole-in-one feeling
2.1.80. being discriminated
2.1.81, being celebrated
2.1.82. any other feeling, emotion, knowledge, wisdom, thought, or mental activity that is “You”—specific to each individual Immordata customer
2.2. At the same time, Immordata customers can keep an Immordata diary, making daily entries and going back to the entries to make updates. This will be convenient and will help Immordata customers to build a habit of daily entries, which will enable the Immordata customers to detail their daily activities, feeling, emotions, reflections, etc., on a daily basis, thus making the collection of Immordata detailed, complete, rich, and comprehensive.

### 3. Building a Future:

3.1. Community Forming: Using existing data, Immordata customers can build their communities of various kinds and levels, such as families, neighborhoods, cities, counties, states, provinces, prefectures, cantons, countries, or even the virtual United Nations.
3.2. Explorations of New Frontiers: Using existing data, Immordata customers can explore new potentials that are not yet thought of by the greatest theorists. But the data stored and operated by Immordata will build a base for them to spring from and provide a venue for such explorations.

### The Different Levels of Data Storage:

Immordata data will be categorized into three different databases, as shown in FIG. 12: public data, limited-access data, and private data (1204), to be detailed below. The purpose of three different levels of data is that some Immordata data can be shared with the public; some may be shared only with families, friends, or authorized legal entities; but some will be private to the individuals only, and, as such, should be use only to be evoked at such a time as deemed appropriate by Immordata and the Immordata Congress to build individual immortality when such technology avails itself.

1. The Public Immordata Data: Immordata customers will store data here that, is made public to varying groups:
1.1. Data public to everyone: This is the kind of data the Immordata customers will choose to be made public to anyone browsing the Immordata public information areas.
1.2. Data to be shared only with varying circles: This is the kind of data the Immordata customers will choose to be made available only to people he/she will give consent to, such as friends, families, special groups, clubs, organizations, or whomever.
2. The Confidential Immordata Data for Families, Friends, Groups, and Communities of Their Choice: Immordata customers will store data here that will be shared with families and friends or authorized legal entities, such as doctors and lawyers, who have access to it. The data will not be available to the general public, but will be shared among Immordata customers who are granted the access by the Immordata customer, so that data can be shared within limited circles. The access can be granted or revoked by the Immordata customer who has created the data, but Immordata and the Immordata Congress will have the ultimate decision on whether the access should be granted, based on the power it is granted by the concurrent law.
3. The Private Immordata Data: Immordata customers will store data here that is guarded and will not be shared with anyone, as in the case of lawyer-client or physician-patient privileges, to be only used to build immortality for Immordata customers. Even when such information is used to build immortality for Immordata customers, this information will be used only for the immortal individual, not shared with anyone else in any situation for any purpose. It shall never be made public forever. This database is the crux of the trust between Immordata and its customers, without which Immordata cannot function or survive as a viable venue, method, or process to store our customers' data for purposes of immortality.

### How It Benefits Mankind

The benefits of the present invention are many:

### 1. Learning Forever

1.1. In the electronic form this Immordata existence will enable every consciousness or soul to learn forever, when the technology makes it possible for the immortal consciousness or soul to be live again.
1.2. The assumption is that all human short comings of the mind are rooted in the fact that the biological and neurological mind was constrained and confined within the biological boundaries of the human brain. A fully developed mind, in a form other than biological, will transcend its biological roots and rise above them to great heights of enlightenment, understanding, capabilities, and unlimited achievements.

### 2. Full Utilization of Latent Human Intelligence:

2.1. We know much knowledge, wisdom, and creativity pass with the passing of a great mind or any mind. The recording or storage of these great minds could prevent such passing or loss. Just imagine, how many more ideas were still floating in Einstein's mind when he passed? And how many patent examiners like Einstein have passed without: writing down his or her great ideas? What would have happened if Leonardo de Vinci had written down his helicopter idea in more detail before his passing? Could the modern helicopter have been invented centuries earlier? Just imagine all the great ideas and minds of the billions of humans that have not been made known. How do we know those hidden or private ideas will not transform humanity entirely? What if suddenly we can harvest all those ideas and communicate all those ideas to each other for further advances? Could the human civilization see quantum leaps forward as a result?
2.2. I think it is a sure bet that, with the establishment of Immordata and later the evocation of Immordata to form immortal individuals and communal human immortality, this sea of knowledge, the vast collection of ideas, the immense wisdom, the endless scientific and technological know-how, and all that the human minds possess will make the human race not only a better race, but also a far more powerful race, enabling it: to achieve things one cannot even possibly imagine at this point in time.

### 3. Next Stage of Human Development

3.1. Humans will probably no longer form prejudices related to physical attributes because the ultimate existence is in the realm of bio-electronics or some other advanced form.
3.2. It is possible that all souls will be connected in some form, thus forming a collective consciousness, which, as a part of the collective whole, is far more powerful, potent, productive, and beneficial than otherwise.
3.3. The probable immortal world in a form other than biological, such as the Singularity, also has a higher level or survivability, if we are to survive the disintegration of the universe in, say, 30 billion years, or in any length of time in which our universe will last.
3.4. This immortal world will enable souls or consciousness to continue to learn.
3.5. Because of this continuous learning, the souls and consciousnesses will evolve into higher beings with higher moral standards and better understanding, thus improving the souls and consciousnesses. Because of all that development, evil spirits and debased souls will transform to become better souls and consciousnesses.
3.6. Souls and consciousness will then command vast reservoirs of knowledge, thus being able to make better decisions, make new discoveries, improve the world tremendously, and eventually even find ways to survive the collapse of this universe and transport into another universe, were that to happen, to continue the human race and the human consciousness.

The above features and advantages and other features and advantages of the present invention are readily apparent from the following detailed description of the best modes for carrying out the invention when taken in connection with the accompanying drawings.

Although the invention has been described in detail in the foregoing embodiment for the purpose of illustration, it is to be understood that such detail is solely for that purpose and that variations can be made therein by those skilled in the art without departing from the spirit and scope of the invention except as it may be described by the following claims.

1. A storage and retrieval system and method of entering, creating, recording, sharing, and permanently storing personal and communal electronic data for a customer in order for said customer to create a permanent database, share said permanent database with a community, build personal and communal human heritage, and record personal consciousness, to be available for retrieval at a future time.

2. The method in claim 1 wherein said method entails various data generation, sharing, storing, and retrieval processes and steps, comprising:
(a) accepting said customer's written recollection of present or past activities, events, feelings, emotions, reflections, memories of said customer's life, of persons that said customer has met or knows of, of said customer's accomplishments, of said customer's knowledge, of places that said customer has visited or read about or knows otherwise, of said customer's dreams, of said customer's desires, and of any other mental activity of said customer,
(b) providing said customer with a web-based interface through which said customer can create, store, and share audio and video recordings of any kind and any other kind of electronic data,
(c) providing said customer with a web-based access through which said customer can convert a written diary, an essay, a picture, or any physical materials into any kind of electronic data for said customer to store and share said electronic data, whereby said customer will create a permanent database and collection of said customer's mental activities, to be permanently stored, maintained, and preserved, and whereby said permanent database will exist and provide data that may be retrieved and revived for individual human and communal immortality for said customer when future technologies avail themselves to build said individual human and communal immortality.

3. The method in claim 1 wherein a process will maintain a database and a physical collection for said customer for perpetuity based on a financing plan.

4. The financing plan in claim 3 wherein an agreed-upon financing arrangement establishes a principal either in one of a lump sum payment and a series of payments by said customer to generate interest based on said principal to bear costs to perpetually maintain said permanent database for future selective retrieval.

5. The method in claim 1 wherein said database and collections are to be classified into three categories, comprising:
(a) a public database in which a method, a process, and a location are provided for said customer to store permanently or temporarily said customer's data in a public database for public viewing and sharing,
(b) a communal database in which a method, a process, and a location are provided for said customer to store permanently or temporarily said customer's data and physical collection to create a communal database to be shared with a community,
(c) a private database in which a method, a process, and a location are provided for said customer to store permanently said customer's private data to create a permanent private database, revise said private database, and change and retrieve said private physical collection.

6. The public database collection in claim 5 wherein said public database is open for data retrieval by any person who has a physical venue to access said public database.

7. The communal database in claim 5 wherein said communal database is to be open for data retrieval to a person when said person is given access to said communal database by said customer.

8. The private database in claim 5 wherein said private database is to be permanently stored for said customer in perpetuity to be accessed only by said customer and eventually retrieved to reestablish said customer's consciousness as authorized by an executive committee.

9. The executive committee in claim 8 wherein said executive committee is to be established to include a congress of world's best scientists and scholars, most outstanding citizens, prominent political leaders, and other such personnel as suitable to decide a proper time to evoke information in said private database, in said communal database, and in public database, to reestablish immortal personal consciousness and allow said individual consciousness to live again eternally and interact with one another.

10. The communal database in claim 5 wherein said communal database will provide a process and a venue in the form of a community website for said customer to share said communal database with a family and other communities.

11. The process and space in claim 10 wherein a family tree for said family to build, update, and share with a family member or a person who is Oven access by said family to said family tree or a public audience with a web-based access.

12. The process and space in claim 10 wherein a family room, in the form of a community website, for said family to share information, conduct live Internet gatherings or reunions for members of said family, record activities, thoughts, feelings, audio-visual effects, and all other information of said family, plan events for said family, send reminders to members of said family for birthdays, gatherings, and any other event, and create a permanent database for said family.

13. The process and space in claim 10 wherein a family nursery for said family to create a permanent database for a child to record said child's activities, events, audio-visual effects, or any other data, to be transferred to said child at a more mature age, as a child at a given young age may not be able to properly record said child's own activities, events, audio-visual effects, or any other data.

14. The process and space in claim 10 wherein a family medical center for said family to store medical, biological, and genetic information of members of said family, to be shared with members of said family or a doctor or any other person who has been given permission from said members of said family.

15. The process and space in claim 10 wherein a family living will center for said family to store, share, and process family wills, to be shared by members of said family with members of said family or other persons who have been given permission and authorization by said family to access said family wills.

16. The process and space in claim 10 wherein a family immortal database is created by said family and maintained for said family to process and store data for said family in perpetuity.

17. The process and space in claim 10 wherein a family physical collection process is created for said family to relationally store personal artifacts of said family for perpetuity.

18. The communal database in claim 5 wherein a process and a space are provided for said customer to share said communal database with a community, comprising:
(a) providing any groups, associations, clubs, or any other organization with a process and website to conduct activities and generate, share, and store temporary or permanent data for said groups, associations, clubs, or any other organization by using said process and website,
(b) providing any neighborhood with a process and website to conduct activities and generate, share, and store temporary and permanent data for said neighborhood by using said process and website,
(c) providing any town, city, borough, or any other civic organization with a process and website to conduct activities and generate, share, and store temporary or permanent data for said town, city, borough, or any other civic organization by using said process and website,
(d) providing any state, province, prefecture, and any other administrative entity with a process and website to conduct activities and generate, share, and store data for said state, province, prefecture, or any other administrative entity by using said process and website,
(e) providing any independent country, state, or any other sovereign entity with a process and website to conduct activities and generate, share, and store temporary or permanent data for said country, state, or any other sovereign entity by using said process and website,
(f) providing any college, university, or any other educational institution with a process and website to conduct activities and generate, share, and store temporary or permanent data for said college, university, or any other educations institution by using said process and website,
(g) providing any race or ethnicity or any other cultural entity with a process and website to conduct activities and generate, share, and store temporary or permanent data for said race, ethnicity, or any other cultural entity by using said process and website,
(h) providing all humans with a process and website to generate, share, and store temporary or permanent data for all humans by using said process and website, thus providing a database to create a permanent humanity.

19. An electronic data storage and retrieval database and system wherein a customer can enter, share, and permanently store said customer's personal and communal written, audio, video, or any other electronic data based on a financing plan to establish a principal where said principal will generate interest to bear costs to pay for permanent storage of said personal and communal written, audio, video, and any other electronic data, comprising:
(a) a database in which data is stored by said customer in a relational database,
(b) accepting said customer's data when entered through a networked Internet interface,
(c) storing said customer's data in a relational database for selective retrieval,
(d) connecting through a networked Internet interface to said customer's computer and cell phone for data entry and retrieval,
(e) performing searches in a plurality of criteria to retrieve stored customer data,
(f) retrieving and presenting relevant data resulting from said searches.

20. A physical storage where a customer can deposit, share, and permanently store said customer's physical artifacts and biological data and materials based on a financing plan to establish an endowment where said endowment will generate interest to bear costs to pay for permanent storage of said physical artifacts and biological data and materials, wherein said physical artifact and biological data and materials will be classified into three categories, comprising:
(a) storing said customer's physical artifacts and biological data and materials in secure locations,
(b) providing said customer with the option to categorize said customer's physical artifact and biological data and materials in categories of a public category, which is open to any public viewing by a person who has a way to view said physical artifacts and biological data and materials, and a communal category, which is open to a person who has to obtain permission from a community to view or use said physical artifacts and biological data and materials, and a private category, which is to be accessed only by said customer and executors authorized by said customer,
(c) making relational said customer's physical artifacts and biological data and materials to said customer's other electronic data storage in a database as defined by said customer.
